(19) United States
(12) Patent Application Publication
(10) Pub. No.: US 2014/0380477 A1
(43) Pub. Date: Dec. 25, 2014

(54) METHODS AND DEVICES FOR IDENTIFYING TAMPERED WEBPAGE AND INENTIFYING HIJACKED WEB ADDRESS

(71) Applicant: BEIJING QIHOO TECHNOLOGY COMPANY LIMITED, Xicheng, Beijing (CN)

(72) Inventors: Jifeng Li, Beijing (CN); Peijian Yan, Beijing (CN); Wu Zhao, Beijing (CN)

(21) Appl. No.: 14/368,992

(22) PCT Filed: Dec. 27, 2012
(86) PCT No.: PCT/CN2012/087640

§ 371 Date: Jun. 26, 2014

(30) Foreign Application Priority Data
Dec. 30, 2011 (CN) 201110456055.X
Dec. 30, 2011 (CN) 201110456172.6

(51) Int. Cl. H04L 29/06; G06F 17/30

(52) U.S. Cl. CPC H04L 63/1466; G06F 17/30864
USPC 726/23

(57) ABSTRACT

Disclosed are methods and devices for identifying a tampered webpage and identifying a hijacked web address. The method for identifying a tampered webpage comprises: by simulating a mode of inputting a URL in an address bar of a browser, initiating a request to access a target webpage, and determining obtained page content as the first page content; by simulating a mode of jumping from a link, initiating a request to access the target webpage, and determining obtained page content as the second page content; comparing the first page content with the second page content to obtain a comparison result; and identifying, according to the comparison result, whether the target webpage is a tampered webpage. The present invention can effectively identify whether a target webpage is a tampered webpage, so that an effective means for determining whether a target webpage is tampered is provided to a user and computer services.

### FIELD OF THE INVENTION

The present invention relates to the field of computer technology, and particularly to methods and devices for identifying a tampered webpage and identifying a hijacked web address.

### BACKGROUND OF THE INVENTION

Electronic government and electronic commerce prevail increasingly nowadays, and a website has become a window for a government agency, enterprise or public institution to show its image. Websites of various agencies and units are established successively to provide an effective means for the agencies or units to release information, provide services, develop business or the like, and also bring about huge convenience. However, if a website's web address is hijacked, it will not only affect normal development of work, but also exert uncountable negative influence on government reputation and enterprise image. Even worse, some hackers carry out criminal activities such as instigation and fraud by hacking means such as hijacking a web address, which causes loss to the agency or unit or the masses. If a governmental website is hacked, once the web address is hijacked, correct information cannot be obtained by the general public when browsing the website's webpage, which will cause serious harm to governmental image. Besides, some ill-intentioned people might, by drawing on people's trust in governmental website, hijack the web address, spread rumor and cause unnecessary panic and suspicion to people, thereby causing huge loss to the nation and people.

Besides, if various agencies and units' websites are tampered, this not only affects normal development of work, but also exerts uncountable negative influence on enterprise image and government reputation. Even worse, some lawbreakers carry out criminal activities such as defrauding by tampering a webpage. If a governmental website's webpage is tampered, particularly a tampering with political attack motivation, serious harm will be caused to governmental image. Besides, some ill-intentioned people might, by drawing on people's trust in governmental website, tamper semantics of webpage, spread rumor and cause unnecessary panic and suspicion to people, thereby causing huge loss to the nation and people.

For instance, if the health and epidemic prevention announcement “Intestinal Flu Virus Found in This Region” on a government website is tampered to “Avian Flu Virus Found in the Region”, and reproduced in succession on the network media, this inevitably causes people's unnecessary panic and huge economic loss. Again for example, if price of a certain goods on an E-commerce website is tampered from RMB1000 Yuan to RMB10 Yuan, which causes throng of orders like snowflakes, the website will be in a dilemma between practical profits and business reputation.

As the Internet develops rapidly, events such as website intrusion or web address hijacking occur frequently. For purposes such as showing of technology, product propaganda and illegal profits, various hacking technologies are abused on the Internet, which seriously damage normal use of the Internet. One of the hacking technologies for hijacking a web address is that when an Internet user clicks a link, what is opened is not a true target website but another well-designed web address, which include meaningless advertisement that wastes the user's browsing time, or unlawful information for propagandizing illegal acts, or even includes virus or Trojan that causes evil destruction to the user's computer. If a lottery official website somewhere is hijacked, the user, after clicking it, sees a website entitled so-called “State Lottery Prediction Research Center”, which induces the user to register and consume so as to make unlawful profits.

### SUMMARY OF THE INVENTION

In view of the above problems, the present invention is proposed to provide a method and device for identifying a tampered webpage and identifying a hijacked web address, which can overcome the above problems or at least partially solve or relieve the above problems.

According to an aspect of the present invention, there is provided a method for identifying a tampered webpage, comprising: by simulating a mode of inputting a URL in an address bar of a browser, initiating a request to access a target webpage, and determining obtained page content as a first page content; by simulating a mode of jumping from a link, initiating a request to access the target webpage, and determining obtained page content as a second page content; comparing the first page content with the second page content to obtain a comparison result; and according to the comparison result, identifying whether the target webpage is a tampered webpage.

According to another aspect of the present invention, there is provided a device for identifying a tampered webpage, comprising: the first page content acquiring unit configured to, by simulating a mode of inputting a URL in an address bar of a browser, initiate a request to access a target webpage, and determine obtained page content as a first page content; a second page content acquiring unit configured to, by simulating a mode of jumping from a link, initiate a request to access the target webpage, and determine obtained page content as a second page content; a comparing unit configured to compare the first page content with the second page content to obtain a comparison result; and an identifying unit configured to identify, according to the comparison result, whether the target webpage is a tampered webpage.

According to a further aspect of the present invention, there is provided a method for identifying a hijacked web address, comprising: by simulating a mode of inputting a URL in an address bar of a browser, initiating a request to access a target web address, and determining obtained final access web address as a first web address; by simulating a mode of jumping from a link, initiating a request to access the target web address, and determining obtained final access web address as a second web address; comparing the first web address with the second web address to obtain a comparison result; and according to the comparison result, identifying whether the target web address is a hijacked web address.

According to another aspect of the present invention, there is provided a device for identifying a hijacked web address, comprising: a first web address acquiring unit configured to, by simulating a mode of inputting a URL in an address bar of a browser, initiate a request to access a target web address, and determine obtained final access web address as a first web address; the second web address acquiring unit configured to, by simulating a mode of jumping from a link, initiate a request to access the target web address, and determine obtained final access web address as a second web address; a comparing unit configured to compare the first web address with the second web address to obtain a comparison result; and an identifying unit configured to identify, according to the comparison result, whether the target web address is a hijacked web address.

According to a further aspect of the present invention, there is provided a computer program which comprises a computer readable code; when the computer readable code is running on a server, the server executes the method according to any one of claims 1-4 and 9-12.

According to still another aspect of the present invention, there is provided a computer readable medium which stores the computer program according to claim 17.

The beneficial s effects of the present invention are as follows.

Firstly, by means of the present invention, a request to access the target webpage is initiated by simulating a mode of inputting a URL in an address bar of a browser, a request to access the target webpage is initiated by simulating a mode of jumping from a link, and the obtained page contents are compared to find difference of the page contents obtained by accessing the target webpage in two modes. As such, the act of tampering a webpage is revealed, and whether the target webpage is a tampered webpage can be effectively identified.

Secondly, by means of the present invention, a request to access the target web address is initiated by simulating a mode of inputting a URL in an address bar of a browser, a request to access the target web address is initiated by simulating a mode of jumping from a link, and the obtained final access addresses are compared to find difference of the final access web addresses obtained by accessing the target web address in two modes. As such, the act of hijacking the web address is revealed, and whether the target web address is a hijacked web address can be effectively identified.

The above description is only an overview of technical solutions of the present invention. The present invention may be implemented according to the content of the description in order to make technical means of the present invention more apparent. Specific embodiments of the present invention are exemplified to make the above and other objects, features and advantages of the present invention more apparent.

### BRIEF DESCRIPTION OF THE DRAWINGS

Various other advantages and benefits will become apparent to those having ordinary skills in the art by reading the following detailed description of the preferred embodiments. The drawings are only intended to illustrate the preferred embodiments, and not to limit the present invention. And throughout the drawings, the same reference signs are used to denote the same components. In the drawings:

FIG. 1 illustrates a flow chart of a method for identifying a tampered webpage according to an embodiment of the present invention;

FIG. 2 illustrates a schematic view of a device for identifying a tampered webpage according to an embodiment of the present invention;

FIG. 3 illustrates a flow chart of a method for identifying a hijacked web address according to an embodiment of the present invention;

FIG. 4 illustrates a schematic view of a device for identifying a hijacked web address according to an embodiment of the present invention;

FIG. 5 illustrates a block diagram of a server for executing the method according to the present invention; and

FIG. 6 illustrates a storage unit for maintaining or carrying a program code for implementing the method according to the present invention.

### DETAILED DESCRIPTION OF THE INVENTION

The present invention will be further described below with reference to the drawings and specific embodiments.

First, it is noticeable that when an Internet user accesses a webpage, no matter by directly inputting a Uniform Resource Locator (URL) in an address bar of a browser or by jumping from a link, actually he sends a HTTP (Hyper Text Transfer Protocol) request to a server through the Internet by means of a browser of a local computer. This HTTP request usually includes one or more necessary or unnecessary request headers or header fields, which include request type information for the request sent to the server.

For example, the request header, Accept-Charset, represents character set information that may be accepted by the browser of the local computer. Again for example, the request header, User-Agent, includes information about operating system used by the user and its version, CPU type, browser and its version, browser rendering engine, browser language, browser plug-in and the like so that the server, by judging specific content of the request header User-Agent, generates and sends different webpages according to computer software and hardware environment used by different users when responding to the user's request. Again for example, a request header Referrer includes a URL, which indicates to the server that this request results from the jumping from the URL included therein, i.e., the user starts from the webpage represented by the URL, and accesses the currently requested webpage. Under the current circumstances of close business cooperation between websites and frequent use of search engines, the request header Referrer is used in most of requests involving webpage jumping, and functions such as facilitating statistics of access data of the server.

In addition, noticeably, nowadays search engines prevail and become an indispensable tool for Internet surfing, and they provide people with information in various fields and provide convenience for people's life. A web crawler, as one of basic integral parts of the search engine, plays an important role in enabling the search engine to provide various information. The web crawler is a program or script that works day and night and can automatically download, analyze and extract webpage information on world-wide-web according to certain rules, and it accesses webpages provided by the web server on the Internet and provides information sources for the search engine. However, in the course of the web crawler accessing the web server, the HTTP header of an access request sent by the web crawler usually includes information content peculiarly held by the search engine. For example, the request header User-Agent includes a web crawler program name peculiarly held by each search engine. For example, the web crawler program of Google search engine is “Googlebot”.

In respect of network security, combat between hackers and secure service provider as well as computer users never cease. When hackers carry out hacking acts, they usually adopt a certain policy to disguise and conceal their own illegal acts so as not to be revealed. As far as webpage tampering is concerned, characteristics of one of hacking technologies may be reflected by the following situation often confronted by a user during browsing the webpage: when the user directly inputs a target web address in the address bar of the browser for browsing, he opens a normal and non-tampered webpage, whereas when he enters the webpage by jumping from a search result of the search engine or links of other webpages, he opens a tampered webpage on which the content is rather distinct from the content of the original webpage, even completely different from the content of the original webpage and completely different from the information to be displayed on the original webpage. As far as web address hijacking is concerned, characteristics of one of hijacking technologies may be reflected by the following situation confronted by a user upon using the Internet: when the user directly inputs a target web address in the address bar of the browser for browsing, he opens a normal target web address, whereas when he opens the target web address by jumping from a search result of the search engine or links of other webpages, a final access web address he opens is a hacker-set web address, not a true target web address. The content presented to the user is often greatly distinct from the target webpage, even completely not the information needed by the user.

An actual situation in practical application is that ordinary Internet users, when opening a new webpage, do not access by directly inputting an actual web address of the webpage in the address bar in most cases, because complete web addresses of most webpages are very long, hard to memorize and time-consuming if the user types the complete web addresses. Therefore, when the user wants to reach a certain webpage, he often resorts to jumping from a search result of a search engine or from links of other webpages. Besides, when surfing on the Internet, the Internet users usually are not definitely purposeful in most of their webpage-opening acts, i.e., when the user finds interesting content in the currently-browsed webpage, he usually jumps from a link in the current webpage to the webpage of his interest.

As for those persons who really care about content of a particular webpage, for example, a website owner and administrator, when they need to enter some particular webpage, they mostly directly input the target web address in the address bar of the browser for browsing since they are familiar with the web address of the particular webpage, instead of browsing by jumping from the search result of the search engine or jumping from links of other webpages to the particular webpage. At this time, what is presented is a non-tampered normal webpage or non-hijacked target web address. It is very difficult for this type of special browsers to perceive tampered content or web address-hijacking acts.

As can be seen from the above, when accessing a webpage, ordinary users mostly adopt a manner of jumping from links, whereas a special group of people such as a website owner or administrator, usually without needs to jump from links, often accesses in a way of directly inputting an actual web address of the webpage in the address bar of the browser so that this group of users, in most cases, cannot find out the tampered content of the webpage or the hijacking of the web address. It is right the characteristics of these webpage-browsing acts that offer an opportunity for hackers who perform webpage tampering or web address hijacking too effectively conceal their own webpage tampering acts or web address hijacking acts.

While implementing the present invention, the inventor finds that there is substantial difference in terms of the presented content or the obtained final access address between the browsing manner by directly inputting a target web address in the address bar of the browser for webpage browsing and the browsing manner of jumping from the search result of the search engine or jumping from links of other webpages to browse the same webpage. From perspective of technical implementation, the cause for the above difference is that during the users' access to the webpage or web address, hackers performing webpage tampering act or web address hijacking act hijack the HTTP request sent by the user when using the browser to browse the webpage, analyze characteristics of the HTTP request, and adopt different means according to different analysis results so that the user obtains different webpage content or different final access web addresses for different webpages. This will be described in detail below.

When the user initiates a request for accessing a webpage, in fact it is the browser sending a HTTP request to the web server. Hackers performing webpage tampering act or web address hijacking act will hijack and analyze the request and perform different processing according to characteristics of the HTTP request. If the requested target web address in the sent browsing request is directly inputted by the user in the address bar of the browser, the HTTP request will be allowed to pass so that the target web server receiving the HTTP request returns the normal webpage content, whereby the content presented on the user browser is normal webpage content not tampered or normal webpage content returned by the target web server. As for a HTTP request sent by the user browser to browse webpage by jumping from the search result of the search engine or from links of other webpages, a tampered webpage will directly returned to the user, or the request is hijacked to jump to a preset web address so that the final access web address obtained by the user is a web address preset by the hackers and the presented content is also the content returned by the hacker-preset web address.

Specifically, the hacker performing webpage tampering act analyzes the hijacked HTTP request sent to the target web server. In fact, what is analyzed by the hacker is the information included in the HTTP header of the HTTP request sent to the target web server. For example, the URL included in the Referrer request header may be obtained by analyzing Referrer request header, i.e., it may be obtained through analysis that the user starts from the webpage represented by which URL to access the currently requested webpage. As such, the hacker performing the webpage tampering act may judge whether the current HTTP request is a HTTP request sent by jumping from a link of a specific webpage. Again for example, the User-Agent request header is analyzed to obtain software information used by the sender of the current HTTP request so that the hacker performing the webpage tampering act may judge what software is used by the sender of the current HTTP request, for example, the browser used by the user, or the crawler program used by the search engine and so on.

The hacker performing webpage tampering act analyzes the hijacked HTTP request sent to the target web server, and determines according to the analysis result whether the HTTP request is allowed to pass and a normal webpage is returned by the target web server of the HTTP request, or a tampered webpage is returned. In this way, this causes difference of content when the same webpage is opened in different manners, and even, search results obtained by crawler programs of some search engines, i.e., the search results of the search engines, also include wrong information.

The hacker performing web address hijacking act analyzes the hijacked HTTP request sent to the target web server, and determines according to the analysis result whether the HTTP request is allowed to pass and a webpage is returned by the target web server of the HTTP request, or a preset web address which returns a webpage to the user is jumped to. In this way, different final access web addresses are obtained by initiating requests to access the same web address in different manners, and the accessed content is also usually different.

Based on above analysis, embodiments of the present invention provide a method for identifying a tampered webpage. Referring to FIG. 1, the method comprises the following steps.

S101: by simulating a mode of inputting a Uniform Resource Locator (URL) in an address bar of a browser, initiating a request to access a target webpage, and determining obtained page content as the first page content;

In an embodiment of the present invention, firstly, a HTTP request is built to simulate a mode of inputting a URL in an address bar of a browser, thereby initiating a request to access a target webpage. This built HTTP request has characteristics of a HTTP access request that is initiated to access the target webpage in a manner of inputting the URL in the address bar of the browser. In the case of initiating a HTTP request to access the target webpage in a manner of inputting the URL in the address bar of the browser, among the request headers, the Referrer request header is usually not included, i.e., there is no Referrer request header in this type of HTTP requests. Besides, the request headers of the built HTTP request includes the User-Agent request header in which the user browser information is built, for example:

User-Agent: Mozilla/5.0 (compatible; MSIE 9.0; Windows NT 6.1; Trident/5.0)

In the example of the User-Agent request header, information such as the user browser type and version, and the version of the user operating system are presented. This User-Agent request header may be identified as a HTTP request header of a HTTP access request to access a target webpage initiated in a manner of inputting the URL in the address bar of the browser.

By building a HTTP request including the above characteristics, the HTTP request to access the target webpage is initiated by simulating the mode of inputting the URL in the address bar of the browser, the built HTTP request is sent to the target web server, and the obtained page content is determined as the first page content.

As this built HTTP request has the characteristics of a HTTP access request that is initiated to access the target webpage in the manner of inputting the URL in the address bar of the browser, if the hackers performing the webpage tampering act hijack and analyze the built HTTP request, according to the hackers' behavior characteristics, they will identify the HTTP access request as a HTTP request to access the target webpage initiated in the manner of inputting the URL in the address bar of the browser, and allow the request to pass, and then the web server returns normal webpage content. Therefore, the obtained first page content in the embodiment of the present invention is normal page content.

S102: by simulating a mode of jumping from a link, initiating a request to access the target webpage, and determining obtained page content as the second page content.

Besides acquiring the first page content, it is also requisite to initiate a request to access the target webpage by building a HTTP request that simulates a mode of jumping from a link. The thus-built HTTP request has characteristics of a HTTP request that is initiated to access the target webpage by jumping from a link. In the case of initiating a HTTP request to access the target webpage by jumping from a link, the HTTP request includes a Referrer request header including URL information, which indicates that this HTTP request results from jumping from the URL included in the Referrer request header, i.e., this HTTP request is a HTTP request to access the current webpage starting from the URL included in the Referrer request header. This Referrer request header may be identified a request header of a HTTP request to access the target webpage initiated by jumping from a link. With the HTTP request including the above characteristic of the Referrer request header being built, the HTTP request to access the target webpage is initiated by simulating the mode of jumping from a link, the built HTTP request is sent to the target web server, and the obtained page content is determined as the second page content.

As this built HTTP request has the characteristic of a HTTP request that is initiated to access the target webpage in the manner of jumping from a link, if the hackers performing the webpage tampering act hijack and analyze the built HTTP request, according to the hackers' behavior characteristics, they will identify the HTTP access request as a HTTP request to access the target webpage initiated by jumping from a link, and then the tampered webpage content is returned. Therefore, in the embodiment of the present invention, if the target webpage is already tampered, the second page content obtained through the built HTTP request is the tampered page content.

S103: comparing the first page content with the second page content to obtain a comparison result.

In practice, there may be many kinds of specific modes for implementing comparison of the first page content with the second page content to obtain a comparison result. For example, one of implementation modes is comparing all content of the first page with all content of the second page to obtain a relatively precise comparison result. In practice, DOM Trees of the first page and the second page may be generated according to HTML codes of the first page and the second page, and comparison is performed according to whether elements on each pair of corresponding nodes of the two DOM Trees are identical.

However, a larger system overhead is needed in comparing all content of the first page with all content of the second page in practical application. Therefore, except the policy of comparing all content of the first page with all content of the second page, another implementation mode employing the following policy may be used: DOM Trees of the first page and the second page may be generated according to HTML codes of the first page and the second page, and comparison is performed between elements on a selected portion of corresponding nodes of the two DOM Trees. As required, the portion of nodes may be selected at random, designated according to a certain policy, or the like.

Furthermore, the comparison may be performed in the following manner: comparing key elements of the first page content with corresponding key elements in the second page content to obtain a comparison result, wherein when determining key elements of the pages, key elements to be compared may be determined according to different actual needs. One of policies for determining to-be-compared key elements may be first considering files included in the pages, such as pictures, flash, audio and video, and content in the pages, such as key characters, key words and page title, as a set of page key elements, and then setting a subset of the set of the page key elements as comparison objects for comparing the key elements of the first page content with the to-be-compared key elements of the second page content. When files such as pictures, flash, audio and video included in the page are regarded as to-be-compared key elements, comparison may be performed according to names, sizes, and verification values of files, wherein the names of the files may be directly obtained from the HTML codes of the pages, and the sizes and verification values of the files may be obtained by calculation.

Specifically, during comparison of the key elements of the first page content and corresponding key elements in the second page content, after key element subsets to be compared are determined, the to-be-compared key elements are found from the first page according to element attributes in the HTML code first, and then corresponding key elements are searched in the second page, and then comparison is performed as to whether these key elements are identical.

There may be many expression modes of comparison result, for example, the comparison result may be classified into completely identical and incompletely identical, and it is also feasible to quantify the comparison result of the first page content and the second page content as a similarity degree between them.

S104: identifying, according to the comparison result, whether the target webpage is a tampered webpage.

In practice, there may be many specific implementations to identify whether the target webpage is a tampered webpage according to the comparison result. One of the specific implementations is identifying the target webpage as a normal webpage or tampered webpage according to the comparison result of completely identical or incompletely identical.

Besides, whether the target webpage is a tampered webpage may be identified according to a specific value of the comparison result as a similarity degree between the first page content and the second page content. This manner has the realistic significance in practical application described below.

In practical application, in order to increase access frequency and search ranking of some webpages in a search engine, thereby raising their popularity, these webpages requires a crawler program of the search engine to crawl their own webpages at a very high frequency. However, if one webpage includes stationary and invariable content, the frequency at which the crawler program crawls this webpage might be reduced, and thereby reducing the probability of jumping to the webpage through the search engine, so that a click rate of the webpage cannot be improved through the search engine. Hence, a webpage maker will deliberately set a portion of content in the webpage that is dynamically changing. Certainly, this portion of dynamically changing content might be only a small portion of all content of the webpage because its purpose is only to increase the frequency of crawling by the crawler program of the search engine, and the remaining majority of content reflecting the subject matter is invariable. However, this still leads to the following actual situation: a very high similarity degree between the first page content and the second page content is obtained by the method according to the embodiment of the present invention, but although the similarity degree cannot be up to 100 percent, the webpage cannot be defined as a tampered webpage. At this time, if the mode of “identifying the target webpage as a normal webpage or tampered webpage according to the comparison result of completely identical or incompletely identical” is directly used for identification, it is possible that some normal webpages be wrongly identified as tampered webpages.

Hence, in order to reduce possibility of erroneous judgment, a policy of “identifying whether the target webpage is a tampered webpage according to a specific value of the comparison result as a similarity degree between the first page content and the second page content” is adopted for the following reasons: if a webpage includes dynamically changing content as deliberately set by the webpage maker, these content is usually only a small portion of the page content; but if a webpage is tampered by a hacker, most of content of the webpage is usually tampered. Therefore, after the contents of two pages are obtained in the manners according to the embodiment of the present invention, if it is found that they are incompletely identical, but they have high similarity degree, the webpage may be treated as a normal webpage, and if they have low similarity degree, the webpage may be treated as a tampered webpage. In practice, a threshold may be preset, and the similarity degree obtained from comparison of the first page content and the second page content is compared with the preset threshold. If the similarity degree is lower than the preset threshold, the target webpage is identified as a tampered webpage; otherwise, the target webpage is identified as a normal webpage. The preset threshold may be set according to actual needs, or a dynamically setting method may be employed to repeatedly practice and calibrate a dynamic threshold so as to select a reasonable value, thereby avoiding the risk of erroneous judgment in the case that some webpages are updated normally but not tampered by the hackers performing webpage tampering acts.

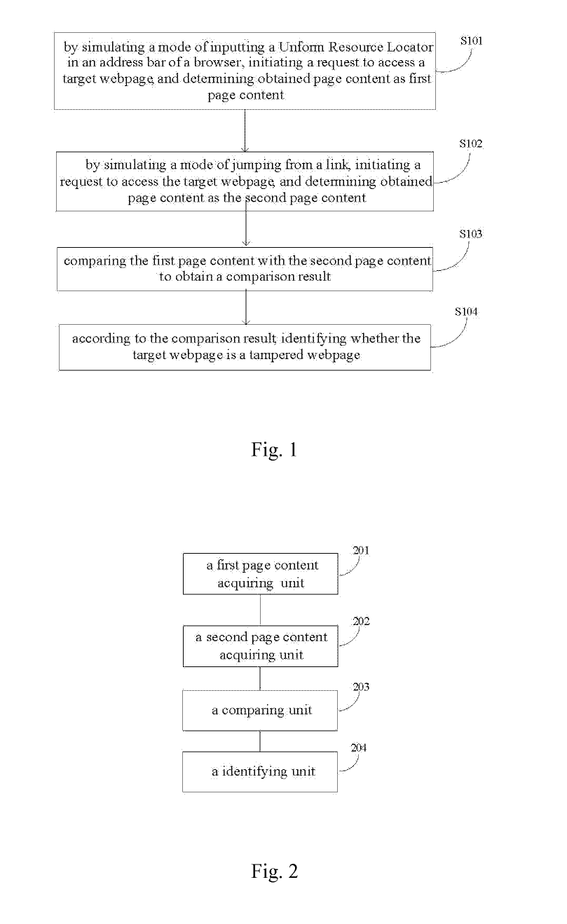

Corresponding to the method for identifying a tampered webpage provided by the embodiments of the present invention, the embodiments of the present invention further provide a device for identifying a tampered webpage. Referring to FIG. 2, the device comprises:

a first page content acquiring unit 201 configured to, by simulating a mode of inputting a URL in an address bar of a browser, initiate a request to access a target webpage, and determine obtained page content as first page content;

a second page content acquiring unit 202 configured to, by simulating a mode of jumping from a link, initiate a request to access the target webpage, and determine obtained page content as the second page content;

a comparing unit 203 configured to compare the first page content with the second page content to obtain a comparison result;

an identifying unit 204 configured to identify, according to the comparison result, whether the target webpage is a tampered webpage.

The second page content acquiring unit 202 may comprise:

a search engine jumping subunit configured to initiate a request to access the target webpage by simulating a mode of jumping from a link in search results given by the search engine.

The comparing unit 203 may comprise:

a key element comparing subunit configured to compare key elements of the first page content and the second page content to obtain a comparison result.

In practice, the comparing unit 203 is specifically configured to:

compare the first page content with the second page content to obtain a similarity degree between the first page content and the second page content.

Correspondingly, the identifying unit 204 is specifically configured to:

identify whether the target webpage is a tampered webpage according to whether the similarity degree between the first page content and the second page content reaches a preset threshold.

By means of the present invention, a request to access the target webpage may be initiated by simulating a mode of inputting a URL in an address bar of a browser, a request to access the target webpage may be initiated by simulating a mode of jumping from a link, and the obtained page contents are compared to find differences of the page contents obtained by accessing the target webpage in two modes. As such, the act of tampering a webpage is revealed, and whether the target webpage is a tampered webpage can be effectively identified.

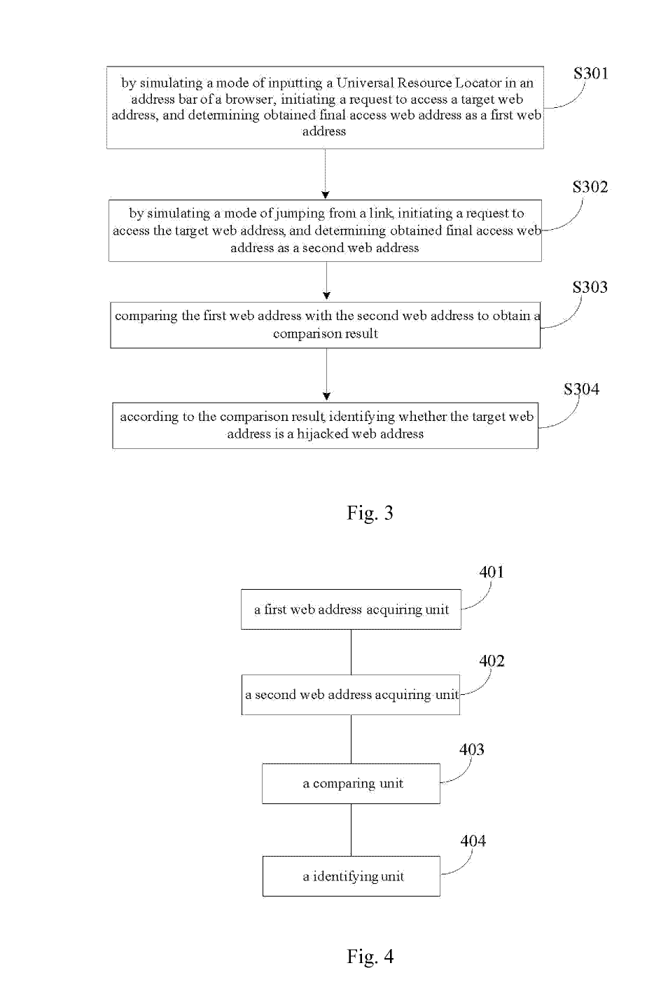

According to another aspect of the present invention, embodiments of the present invention provide a method for identifying a hijacked web address. Referring to FIG. 3, the method comprises the following steps:

S301: by simulating a mode of inputting a Uniform Resource Locator (URL) in an address bar of a browser, initiating a request to access a target web address, and determining obtained final access web address as the first web address.

In this embodiment of the present invention, firstly, a HTTP request is built and initiated to access a target web address by simulating a mode of inputting the URL in the address bar of the browser. This built HTTP request has characteristics of a HTTP access request that is initiated to access the target web address in a manner of inputting the URL in the address bar of the browser. In the case of initiating the HTTP request to access the target web address in a manner of inputting the URL in the address bar of the browser, among request headers, a Referrer request header is not included, i.e., there is no Referrer request header in this type of HTTP requests. Besides, the request headers of the built HTTP request usually includes User-Agent request header in which the user browser information is built, for example:

User-Agent: Mozilla/5.0 (compatible; MSIE 9.0; Windows NT 6.1; Trident/5.0)

In the example of the User-Agent request header are presented information such as the user browser type and version, and the version of the user operating system.

This built HTTP request may be identified as a HTTP request header of a HTTP access request to access a target web address initiated in a manner of inputting the URL in the address bar of the browser. With the HTTP request including the above characteristics being built, the HTTP request to access the target web address is initiated by simulating a mode of inputting the URL in the address bar of the browser, the built HTTP request is sent to the target web server, and the obtained final access web address is determined as the first web address.

As this built HTTP request has the characteristics of a HTTP access request that is initiated to access the target web address in a manner of inputting the URL in the address bar of the browser, if the hackers performing the web address hijacking act hijack and analyze the built HTTP request, according to the hackers' behavior characteristics, they will identify the HTTP access request as a HTTP request to access the target web address initiated in the manner of inputting the URL in the address bar of the browser, and allow the request to pass, and then the requested web server returns content. Therefore, the obtained first web address in this step of the embodiment of the present invention is a true target web address as requested, not a web address set by the hackers performing the web address hijacking act.

S302: by simulating a mode of jumping from a link, initiating a request to access the target web address, and determining obtained final access web address as a second web address.

Besides acquiring the first web address, it is also requisite to initiate a request to access the target web address by building a HTTP request that simulates a mode of jumping from a link. The thus-built HTTP request has characteristics of a HTTP request that is initiated to access the target web address by jumping from a link. In the case of initiating the HTTP request to access the target web address by jumping from a link, the HTTP request includes a Referrer request header including URL information, which indicates that this HTTP request results from jumping from the URL included in the Referrer request header, i.e., this HTTP request is a HTTP request to access the target web address starting from the URL included in the Referrer request header. This Referrer request header may be identified a request header of a HTTP request to access the target web address initiated by jumping from a link.

With the HTTP request including the above characteristic of the Referrer request header being built, the HTTP request to access the target web address is initiated by simulating a mode of jumping from a link, the built HTTP request is sent to the target web server, and the obtained final access address is determined as the second web address.

As this built HTTP request has the characteristic of a HTTP request that is initiated to access the target web address by simulating a mode of jumping from a link, if the hackers performing the web address hijacking act hijack and analyze the built HTTP request, according to the hackers' behavior characteristics, they will identify the HTTP access request as a HTTP request to access the target web address initiated by jumping from a link, and then a preset web address is jumped to and returns the content. Therefore, in the embodiment according to the present invention, if the target web address is already hijacked, the second web address obtained through the built HTTP request is an address set by hackers performing the web address hijacking act, not a true target web address as requested.

S303: comparing the first web address with the second web address to obtain a comparison result;

In practice, there may be many specific modes for implementing comparison of the first web address and the second web address to obtain a comparison result. For example, one of implementation modes is comparing whether the whole first web address is completely identical with the whole second web address to obtain a precise comparison result.

Furthermore, another comparison manner may be employed to obtain the comparison result: comparing domains where the first web address and the second web address lie.

Domain or domain name is one of allocation schemes of computer addresses on the Internet and corresponds to an IP (Internet Protocol) address. Each of computers on the Internet has an IP address expressed by an unique digital sequence to facilitate access by other computers. For ease of memorization, people invent domain name which identifies a computer on the Internet by using a combination of letters, digits and symbols. Domain is a unique identifying number of the computer on the Internet. A digital address of the computer on the Internet can be positioned through the domain to implement access to the computer and communication between computers. For example, accessing a certain website in fact means accessing a computer whereby the website is located on the Intern et, namely, web server, sending a request to the web server, and the web server returns content to the user in response to the request. When accessing a certain web server, its IP address may be used, but more frequently, a domain name of the web server, for example, www.abc.com, is used.

When a user accesses a certain target web address, a main procedure generally is as follows: a client sends a HTTP request to the target web server, the target web server receives and responds to the HTTP request, and the target web server transfers the requested webpage file to the client. In this procedure, the web address requested by the user is generally expressed in the following form:

www.abc.com/d/e/f.html,

wherein domain name section identifies a position of the target web server on the network, and the remaining section, e.g., /d/e/f.html, identifies a storage position of the user-requested file on the web server. It is a general form for the user to access a certain target web address, and also a general form of the final access web address obtained whilst obtaining the page returned by the web server.

Many websites nowadays employ dynamic webpage technology so that the web server may return different content to users according to different users, different settings, different user habits and so on, to meet different needs in different application environments. After different users submit access requests in different application environments, final access web addresses they obtain from the web server might not be completely the same. Besides, some web servers detect application environments of the access request submitters and return different pages and final access web addresses according to detection results. For example, a certain website, according to the user IP address of the access request submitter, judges the user's geographical location area, and then returns to the user the addresses and contents of different pages designed for different areas. Therefore, as far as a web address not hijacked is concerned, the first web address and the second web address obtained by method according to the embodiment of the present invention might not be completely the same, but the domain name sections thereof are the same. For example, the first web address might be www.abc.com/a.html and the second web address might be www.abc.com/b.html. However, this difference is not caused by the hijacking of the web address by hackers. Hence, there might be occurrence of wrong judgment if the first web address and the second web address are directly compared to see whether they are completely the same to judge whether the web address is hijacked.

On the other hand, when hackers perform web address hijacking act, a web address, which is prepared by the hackers to replace the final access web address that is requested by the user and should be returned by the target web server, has the following characteristics: the first web address and the second web address obtained by the method of the embodiment of the present invention are different, and furthermore, they usually have been different at the domain name sections. This is because after hackers hijack a certain web address, the web address, which is prepared by the hackers to replace the final access web address that is requested by the user and should be returned by the target web server, and the page content usually can only be generated from the domain name held by hackers themselves.

In view of the above characteristics, the embodiment of the present invention provides a method of comparing domains where the first web address and the second web address lie, namely, comparing to judge whether the domains where the first web address and the second web address lie are the same to obtain a comparison result. If the comparison result indicates that the domains where the two web addresses lie are the same, the target web address may be regarded as a normal web address, and if the domains where the two web addresses lie are different, it is proved that the target web address might have been hijacked. This method can effectively identify the situation that due to use of dynamic webpage technology, dynamic response technology of the web server, or the like, the obtained first web address and the second web address are somewhat different, but in fact they are not web addresses resulting from the hackers' web address hijacking act.

Besides, in practical application, in order to further confirm whether the target web address is hijacked, it is also feasible to, after identifying that the domains where the two web addresses lie are different, further judge whether the second web address appears in malicious web address database (e.g., a blacklist generated and maintained for purpose of network security). If it is in the blacklist, the target web address is confirmed to have already been hijacked. In other words, if a target web address is hijacked by a hacker, the second web address itself, as being provided by the hacker, is already a malicious web address, and the web address might have already been collected in the blacklist in other manners. As such, if the second web address not only differs from the domain where the second web address lies but also appears in the blacklist, it may be confirmed that the corresponding target web address is indeed hijacked by the hacker.

In one word, by means of the embodiment of the present invention, a request to access the target web address is initiated by simulating a mode of inputting a URL in an address bar of a browser, a request to access the target web address is initiated by simulating a mode of jumping from a link, and the obtained final access addresses are compared to find difference of the final access web addresses obtained by accessing the target web address in two modes. As such, the act of hijacking the web address is revealed, and whether the target web address is a hijacked web address can be effectively identified.

Corresponding to the method for identifying a hijacked web address provided by the embodiments of the present invention, embodiments of the present invention further provide a device for identifying a hijacked web address. Referring to FIG. 4, the device may comprise:

a first web address acquiring unit 401 configured to, by simulating a mode of inputting a URL in an address bar of a browser, initiate a request to access a target web address, and determine obtained final access web address as a first web address;

a second web address acquiring unit 402 configured to, by simulating a mode of jumping from a link, initiate a request to access the target web address, and determine obtained final access web address as a second web address;

a comparing unit 403 configured to compare the first web address with the second web address to obtain a comparison result;

an identifying unit 404 configured to identify, according to the comparison result, whether the target web address is a hijacked web address.

In practice, the second web address acquiring unit 402 may comprise:

a search engine simulating subunit configured to initiate a request to access the target web address by simulating a mode of jumping from a link in search results given by the search engine.

The comparing unit 403 may comprise:

a domain comparing subunit configured to compare domains where the first web address and the second web address lie to obtain a comparison result.

Correspondingly, the identifying unit 404 may comprise:

a first identifying subunit configured to identify the target web address as a hijacked web address if the comparison result indicates that the domains where the first web address and the second web address lie are different.

Or the identifying unit 404 may also comprise:

a second identifying subunit configured to judge whether the second web address appears in a known malicious web address database if the domains where the first web address and the second web address lie are different. If it is, then the target web address is the hijacked web address.

By means of the device provided by the embodiment of the present invention, a request to access the target web address is initiated by simulating a mode of inputting a URL in an address bar of a browser, a request to access the target web address is initiated by simulating a mode of jumping from a link, and the obtained final access addresses are compared to find difference of the final access web addresses obtained by accessing the target web address in two modes. As such, the act of hijacking the web address is revealed, and whether the target web address is a hijacked web address can be effectively identified.

Each embodiment regarding parts in the present invention may be implemented in hardware, or implemented by one or more software modules running on a processor, or implemented in their combinations. It should be understood for those skilled in the art that a microprocessor or digital signal processor (DSP) may be used in practice to implement a part or all of the functions of a part or all of the components of the device according to embodiments of the present invention. The present invention may also be implemented as an apparatus or a device program (e.g., a computer program and a computer program product) for executing a part or all of the methods described herein. Such a program implementing the present invention may be stored in a computer-readable medium, or may be in the form of one or more signals. Such a signal can be obtained by downloading it from the Internet website, or provided on a carrier signal or provided in any other form.

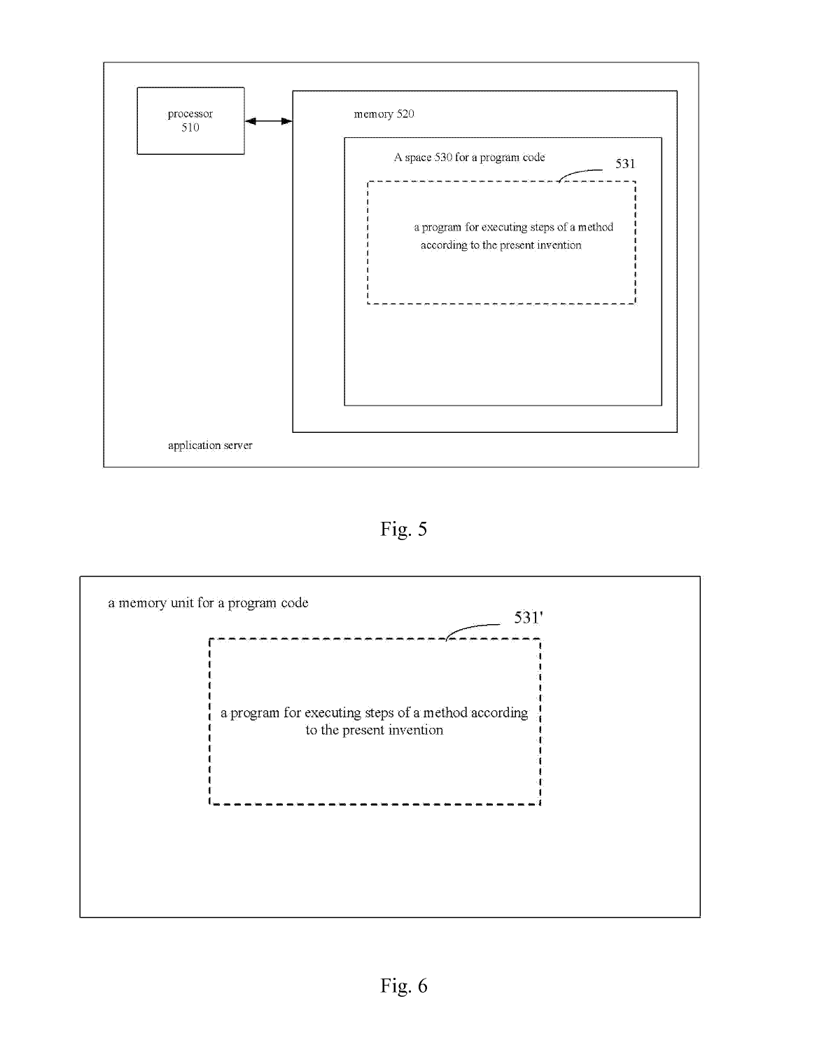

For example, FIG. 5 illustrates a server, e.g., an application server, which can implement a method according to the present invention. The server traditionally comprises a processor 510 and a computer program product or computer-readable medium in the form of a memory 520. The memory 520 may be an electronic memory such as a flash memory, an EEPROM (Electrically Erasable Programmable Read-Only Memory), an EPROM, a hard disk or a ROM. The memory 520 has a memory space 530 for a program code 531 for executing any step of the above method. For example, the memory space 530 for a program code may comprise program codes 531 respectively for implementing steps of the above method. These program codes may be read out from or written to one or more computer program products. These computer program products comprise such a program code carriers as a hard disk, a compact disk (CD), a memory card or a floppy disk. Such a computer program products is generally a portable or stationary storage unit as shown in FIG. 6. The storage unit may have a memory segment, a memory space or the like arranged in a similar way to the memory 520 on the server of FIG. 5. The program code may for example be compressed in an appropriate form. Usually, the storage unit comprises a computer-readable code 531′, namely, a code readable by a processor for example similar to 510. When these codes are run by the server, the server is caused to execute steps of the method described above.

Reference herein to “one embodiment”, “an embodiment”, or to “one or more embodiments” means that a particular feature, structure, or characteristic described in connection with the embodiments is included in at least one embodiment of the invention. In addition, it is to be noted that instances of the phrase “in one embodiment” herein are not necessarily all referring to the same embodiment.

The description as provided here describes a lot of specific details. However, it can be appreciated that an embodiment of the present invention may be implemented in the absence of these specific details. In some embodiments, in order to understand the present description without confusions, methods, structures and technologies well known in the art are not specified in detail.

It should be noted that the above embodiment are intended to illustrate but not to limit the present invention, and those skilled in the art may design alternative embodiments without departing from the scope of the appended claims. In the claims, any reference signs placed between the parentheses should not be construed as limiting to the claims. The word “comprising” does not exclude the presence of an elements or a steps not listed in a claim. The word “a” or “an” preceding an element does not exclude the presence of a plurality of such elements. The present invention may be implemented by virtue of hardware including several different elements and by virtue of a properly-programmed computer. In the apparatus claims enumerating several units, several of these units can be embodied by one and the same item of hardware. The usage of the words such as first, second and third, et cetera, does not indicate any ordering. These words are to be interpreted as names.

In addition, it should be noted that the language used in the specification has been principally selected for readability and instructional purposes, and may not have been selected to delineate or circumscribe the inventive subject matter. Therefore, those having ordinary skill in the art appreciate that many modifications and variations without departing from the scope and spirit of the appended claims are obvious. The disclosure of the present invention is intended to be illustrative, but not limiting, of the scope of the invention, which is set forth in the claims.

1. A method for identifying a tampered webpage, comprising steps of:
by simulating a mode of inputting a URL in an address bar of a browser, initiating a request to access a target webpage, and determining obtained page content as a first page content;
by simulating a mode of jumping from a link, initiating a request to access the target webpage, and determining obtained page content as a second page content;
comparing the first page content with the second page content to obtain a comparison result; and
according to the comparison result, identifying whether the target webpage is a tampered webpage.

2. The method according to claim 1, wherein the step of initiating the request to access the target webpage by simulating the mode of jumping from the link comprises:
initiating the request to access the target webpage by simulating the mode of jumping from the link in search results given by a search engine.

3. The method according to claim 1, wherein the step of comparing the first page content with the second page content to obtain the comparison result comprises:
comparing key elements of the first page content and the second page content to obtain the comparison result.

4. The method according to claim 1, wherein the step of comparing the first page content with the second page content to obtain the comparison result comprises:
comparing the first page content with the second page content to obtain a similarity degree between the first page content and the second page content;
and, the step of identifying whether the target webpage is a tampered webpage according to the comparison result comprises:
identifying whether the target webpage is a tampered webpage according to whether the similarity degree between the first page content and the second page content reaches a preset threshold.

5-18. (canceled)

19. A method for identifying a hijacked web address, comprising steps of:
by simulating a mode of inputting a URL in an address bar of a browser, initiating a request to access a target web address, and determining obtained final access web address as a first web address;
by simulating a mode of jumping from a link, initiating a request to access the target web address, and determining obtained final access web address as a second web address;
comparing the first web address with the second web address to obtain a comparison result; and
according to the comparison result, identifying whether the target web address is a hijacked web address.

20. The method according to claim 19, wherein the step of initiating the request to access the target web address by simulating the mode of jumping from the link comprises:
initiating the request to access the target web address by simulating the mode of jumping from the link in search results given by a search engine.

21. The method according to claim 19, wherein the step of comparing the first web address with the second web address to obtain the comparison result comprises:
comparing domains where the first web address and the second web address lie to obtain the comparison result.

22. The method according to claim 21, wherein the step of identifying whether the target web address is a hijacked web address according to the comparison result comprises:
determining the target web address as a hijacked web address if the comparison result indicates the domains where the first and second web addresses lie are different.

23. The method according to claim 21, wherein the step of identifying whether the target web address is a hijacked web address according to the comparison result comprises:
determining the target web address as a hijacked web address if the comparison result indicates the domains where the first and second web addresses lie are different and if the second web address appears in a known malicious web address database.

24. A computer readable medium storing therein a computer program which comprises a computer readable code, wherein when the computer readable code is running on a server, the server executes in a method for identifying a tampered webpage comprising steps of:
by simulating a mode of inputting a URL in an address bar of a browser, initiating a request to access a target webpage, and determining obtained page content as a first page content;
by simulating a mode of jumping from a link, initiating a request to access the target webpage, and determining obtained page content as a second page content;
comparing the first page content with the second page content to obtain a comparison result; and
according to the comparison result, identifying whether the target webpage is a tampered webpage.
